(19) United States
(12) Patent Application Publication
(10) Pub. No.: US 2025/0256973 A1
(43) Pub. Date: Aug. 14, 2025

(54) STRUCTURES OF LAMELLAR MESOPOROUS CRYSTALLINE MICROPOROUS MATERIAL

(71) Applicants: Saudi Arabian Oil Company, Dhahran (SA); King Abdullah University of Science and Technology, Thuwal (SA)

(72) Inventors: Robert Peter Hodgkins, Dhahran (SA); Omer Refa Koseoglu, Istanbul (TR); Rajesh Kumar Parsapur, Thuwal (SA); Kuo-Wei Huang, Thuwal (SA); Magnus Rueping, Thuwal (SA); Anissa Bendjeriou-Sedjerari, Thuwal (SA)

(73) Assignees: SAUDI ARABIAN OIL COMPANY, Dhahran (SA); King Abdullah University of Science and Technology, Thuwal (SA)

(21) Appl. No.: 18/441,526

(22) Filed: Feb. 14, 2024

(51) Int. Cl. C01B 39/02; C01B 39/20

(52) U.S. Cl. CPC C01B 39/026; C01B 39/20; C01P 2002/72; C01P 2004/04; C01P 2004/24

(57) ABSTRACT

Methods and compositions disclosed concern exfoliated or delaminated lamellar mesoporous crystalline microporous material (CMM), including exfoliated or delaminated layers of a zeolite. In certain embodiments herein methods and compositions concern exfoliated or delaminated FAU zeolite, for example discrete layers of FAU zeolite, obtained by exfoliating/delaminating of a non-pillared two dimensional FAU zeolite comprising layered/stacked sheets.

### FIELD OF THE DISCLOSURE

The present disclosure generally relates to exfoliated or delaminated structures based on lamellar mesoporous crystalline microporous material.

### BACKGROUND OF THE DISCLOSURE

Faujasite zeolites (also known as FAU zeolites, zeolites having FAU framework or FAU-type zeolites) are well-known and are commercially useful zeolites. FAU zeolites generally include zeolite Y (also known as Na-Y zeolite or Y-type faujasite zeolite) and zeolite X. Like typical zeolites, faujasite is synthesized from alumina and silica sources, in the presence of a basic aqueous solution and crystallized. Typically, faujasite is in sodium form and can be ion exchanged with ammonium, and an ammonium form can be calcined to transform the zeolite to its proton form. Zeolite Y is a well-known material for its zeolites have ion-exchange, catalytic and adsorptive properties. Zeolite Y is also a useful starting material for production of ultra-stable Y-type zeolite (USY). In addition, FAU zeolite is also a useful starting material for production of CHA zeolite.

While FAU zeolites are useful for their intended purposes, hierarchical FAU zeolites of lamellar structure were previously unknown until recently. United Stated patent application Ser. No. 17/857,572 filed on Jul. 5, 2022 entitled “Hierarchically Ordered Crystalline Microporous Materials with Long-Range Mesoporous Order Having Lamellar Symmetry” discloses such hierarchical FAU zeolites.

There remains a need in the art for improved lamellar zeolite structures, including exfoliated or delaminated structures based on lamellar mesoporous crystalline microporous material.

### SUMMARY OF THE DISCLOSURE

Methods and compositions disclosed concern exfoliated or delaminated lamellar mesoporous crystalline microporous material (CMM), including exfoliated or delaminated layers of a zeolite. In certain embodiments herein methods and compositions concern exfoliated or delaminated FAU zeolite, for example discrete layers of FAU zeolite, obtained by exfoliating/delaminating of a non-pillared two dimensional FAU zeolite comprising layered/stacked sheets.

In certain embodiments a composition comprising lamellar FAU zeolite in sheets of thicknesses of about 3-2000 nanometers. In certain aspects, the thickness of the sheets is about 3-1000 nanometers. In certain aspects, the thickness of the sheets is about 3-500 nanometers. In certain aspects, the thickness of the sheets is about 3-100 nanometers. In certain aspects, the thickness of the sheets is about 3-50 nanometers. In certain aspects, the sheets are derived from exfoliation or delamination of lamellar FAU zeolite including a supramolecular template material between layers of the lamellar FAU zeolite.

In certain embodiments methods to obtain sheets of lamellar crystalline microporous material are provided, comprising: dispersing lamellar mesoporous crystalline microporous material (LMCMM) and exfoliating agent, wherein LMCMM includes a supramolecular template material between layers of lamellae, to yield a suspension of LMCMM and exfoliating agent; dispersing separating agent in the suspension of LMCMM and exfoliating agent to produce a suspension of separating agent, LMCMM and exfoliating agent; and recovering separated sheets of crystalline microporous material from the suspension of separating agent, LMCMM and exfoliating agent.

In certain aspects, recovering sheets of crystalline microporous material from the suspension of separating agent, LMCMM and exfoliating agent is by separating the sheets of crystalline microporous material from a supernatant. In certain aspects, all or a portion of the supernatant is redispersed into the suspension of separating agent, LMCMM and exfoliating agent. In certain aspects, the method further comprises dispersing additional separating agent in the recovered sheets of crystalline microporous material to form an additional suspension, and recovering further separated sheets of crystalline microporous material from the additional suspension. In certain aspects, recovering separated sheets of crystalline microporous material from the suspension of separating agent, LMCMM and exfoliating agent comprises centrifuging and recovering solids from the top 10-50% after centrifuging.

In certain aspects, the exfoliating agent comprises a polymer selected from the group consisting of polystyrenes, polybutadienes, polylactic acids, polyvinylpyrrolidones, polyethyleneimines and combinations of one or more of the foregoing polymers. In certain aspects, the exfoliating agent comprises a polybutadiene. In certain aspects, the polybutadiene is selected from the group consisting of hydroxyl-terminated polybutadiene (HTPB), carboxyl-terminated polybutadiene (CTPB), polybutadiene, and combinations of one or more of the foregoing polybutadienes.

In certain aspects, the separation agent is a solvent selected from the group consisting of toluene, dichloromethane (DCM), chloroform, n-octanol, chlorobenzene, chloromethane, and combinations of one or more of the foregoing solvents. In certain aspects, the separation agent comprises toluene.

In certain aspects: dispersing the LMCMM and exfoliating agent is by sonication or ultrasonication and occurs for a time period of about 0.2-5 hours, at a temperature of about 20-60° C., and at a mass ratio of LMCMM to exfoliating agent of about 1:4-1:20; dispersing separating agent in the suspension of LMCMM and exfoliating agent is by sonication or ultrasonication and occurs for a time period of about 0.2-5 hours, at a temperature of about 20-60° C., and at a mass ratio of LMCMM to separating agent of about 1:25-1:1000; and recovering separated sheets of crystalline microporous material from the suspension of separating agent, LMCMM and exfoliating agent is by centrifugation and decanting.

In certain aspects, the crystalline microporous material is a zeolite having a framework selected from the group consisting of ABW, ACO, AEI, AEL, AEN, AET, AFG, AFI, AFN, AFO, AFR, AFS, AFT, AFV, AFX, AFY, AHT, ANA, ANO, APC, APD, AST, ASV, ATN, ATO, ATS, ATT, ATV, AVE, AVL, AWO, AWW, BCT, BEC, BIK, BOF, BOG, BOZ, BPH, BRE, BSV, CAN, CAS, CDO, CFI, CGF, CGS, CHA, -CHI, -CLO, CON, CSV, CZP, DAC, DDR, DFO, DFT, DOH, DON, EAB, EDI, EEI, EMT, EON, EPI, ERI, ESV, ETL, ETR, ETV, EUO, EWO, EWS, EZT, FAR, FAU, FER, FRA, GIS, GIU, GME, GON, GOO, HEU, IFO, IFR, -IFT, -IFU, IFW, IFY, IHW, IMF, IRN, IRR, -IRY, ISV, ITE, ITG, ITH, ITR, ITT, -ITV, ITW, IWR, IWS, IWV, IWW, JBW, JNT, JOZ, JRY, JSN, JSR, JST, JSW, KFI, LAU, LEV, LIO, -LIT, LOS, LOV, LTA, LTF, LTJ, LTL, LTN, MAR, MAZ, MEI, MEL, MEP, MER, MFI, MFS, MON, MOR, MOZ, MRT, MSE, MSO, MTF, MTN, MTT, MTW, MVY, MWF, MWW, NAB, NAT, NES, NON, NPO, NPT, NSI, OBW, OFF, OKO, OSI, OSO, OWE, -PAR, PAU, PCR, PHI, PON, POR, POS, PSI, PTO, PTT, PTY, PUN, PWN, PWO, PWW, RHO, -RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, SFW, SGT, SIV, SOD, SOF, SOR, SOS, SOV, SSF, SSY, STF, STI, STT, STW, -SVR, SVV, SWY, -SYT, SZR, TER, THO, TOL, TON, TSC, TUN, UEI, UFI, UOS, UOV, UOZ, USI, UTL, UWY, VET, VFI, VNI, VSV, WEI, -WEN, YFI, YUG, ZON, *BEA, *CTH, *-EWT, *-ITN, *MRE, *PCS, *SFV, *-SSO, *STO, *-SVY and *UOE. In certain aspects, the crystalline microporous material is a zeolite having a framework selected from the group consisting of AEI, *BEA, CHA, FAU, MFI, MOR, LTL, LTA and MWW. In certain aspects, the crystalline microporous material is a zeolite having FAU framework.

In certain aspects, the LMCMM comprises hierarchically ordered crystalline microporous material having well-defined long-range mesoporous ordering of lamellar symmetry comprising mesopores having walls of crystalline microporous material and a mass of mesostructure between mesopores of crystalline microporous material, wherein at least a portion of the mesopores contain micelles of supramolecular templates shaped to induce mesoporous ordering of lamellar symmetry, and wherein the supramolecular templates possess one or more dimensions larger than dimensions of micropores of the crystalline microporous material to constrain diffusion into micropores of the crystalline microporous material, wherein the dimensions relate to a head group of a supramolecular template, a tail group of a supramolecular template, or a co-template arrangement that constrain diffusion into micropores of the crystalline microporous material. In certain aspects, the LMCMM comprises hierarchically ordered crystalline microporous material having a high-degree of long-range mesoporous ordering, and wherein the LMCMM is synthesized by: forming an aqueous suspension of a parent crystalline microporous material having an underlying microporous structure, an alkaline reagent and a supramolecular template; and hydrothermally treating the aqueous suspension under conditions effective for mesophase transition to dissolve/incise parent crystalline microporous material into oligomeric units of the parent crystalline microporous material, form shaped micelles of the supramolecular template, and reorganize the oligomeric units around the shaped micelles into hierarchically ordered mesostructures. In certain aspects, the aqueous suspension further comprises an ionic co-solute. In certain aspects, the parent crystalline microporous material comprises FAU zeolite, the alkaline agent comprises urea, and the ionic co-solute comprises perchlorate.

In certain aspects, a lamellar mesophase of the LMCMM possesses p2 or p1 or pm symmetry. In certain aspects, a lamellar mesophase of the LMCMM possesses p2 symmetry and secondary peaks in XRD are present at a (200) reflection. In certain aspects, long-range ordering of the LMCMM is observable by microscopy viewing an electron beam parallel or perpendicular to a zone axis.

In certain aspects, the supramolecular template contains at least one quaternary ammonium group, and at least one head group moiety selected from the group consisting of organosilanes, hydroxysilyls, alkoxysilyls, aromatics, branched alkyls, sulfonates, carboxylates, phosphates and combinations comprising one of the foregoing moieties, wherein an alkyl group bridging at least one of the quaternary ammonium groups and at least one of the head groups contains 1-10 carbon atoms. In certain aspects, the supramolecular template comprises dimethyloctadecyl(3-trimethoxysilyl-propyl)-ammonium or a derivative of dimethyloctadecyl(3-trimethoxysilyl-propyl)-ammonium.

In certain embodiments, methods to obtain sheets of lamellar FAU zeolite comprise: dispersing lamellar FAU zeolite and exfoliating agent, wherein lamellar FAU zeolite includes a supramolecular template material between layers of lamellae, to yield a suspension of lamellar FAU zeolite and exfoliating agent; dispersing separating agent in the suspension of lamellar FAU zeolite and exfoliating agent to produce a suspension of separating agent, lamellar FAU zeolite and exfoliating agent; and recovering separated sheets of crystalline microporous material from the suspension of separating agent, lamellar FAU zeolite and exfoliating agent.

Any combinations of the various embodiments and implementations disclosed herein can be used. These and other aspects and features can be appreciated from the following description of certain embodiments and the accompanying drawings and claims.

### BRIEF DESCRIPTION OF THE DRAWINGS

FIG. 1 is a process flow chart of a method to make exfoliated or delaminated structures based on lamellar mesoporous crystalline microporous material.

FIG. 2 is a schematic overview of a method to make exfoliated or delaminated structures including steps to synthesize lamellar mesoporous crystalline microporous material.

FIG. 3A depicts low-angle x-ray diffraction patterns of a synthesized lamellar FAU zeolite.

FIG. 3B depicts high-angle x-ray diffraction patterns of the synthesized lamellar FAU zeolite.

FIG. 4A, FIG. 4B and FIG. 4C depict TEM micrographs of the synthesized lamellar FAU zeolite.

FIG. 5A, FIG. 5B and FIG. 5C are TEM images of exfoliated lamellar FAU zeolite.

### DETAILED DESCRIPTION OF CERTAIN EMBODIMENTS OF THE DISCLOSURE

In certain embodiments herein methods and compositions concern exfoliated or delaminated lamellar mesoporous crystalline microporous material (CMM), including exfoliated or delaminated layers of a zeolite. In certain embodiments herein methods and compositions concern exfoliated or delaminated FAU zeolite.

In certain embodiments a composition of matter herein comprises discrete layers of FAU zeolite, obtained by exfoliating/delaminating of a non-pillared two dimensional FAU zeolite comprising layered/stacked sheets.

Embodiments herein concern hierarchical zeolites including hierarchically ordered zeolites, in particular lamellar structures. These structures are in the form of a stack of two dimensional layers, with individual layers possessing a thickness of up to a few nanometers. Whereas zeolites and other crystalline microporous materials have found great utility in their ability to select between small molecules and different cations, mesoporous solids (pores between about 20 and 500 Å) offer possibilities for applications for species up to an order of magnitude larger in dimensions such as nanoparticles and enzymes. The comparatively bulky nature of such species hinders diffusion through the microporous zeolite network, and thus, a larger porous system is required to effectively perform an analogous molecular sieving action for the larger species. In certain embodiments the lamellar structures possess long-range order with a periodically aligned pore structure and uniform pore sizes on the mesoscale. In certain embodiments the lamellar structures comprise lamellar mesoporous CMM possessing long-range order with a periodically aligned pore structure and uniform pore sizes on the mesoscale, which offer high surface area and can be used as host materials to introduce additional functionality for a diverse range of applications such as adsorption, separation, catalysis, drug delivery and energy conversion and storage.

Provided herein are methods to obtain exfoliated or delaminated layers of lamellar mesoporous crystalline microporous material. In certain embodiments the exfoliated layers of lamellar mesoporous crystalline microporous material comprise lamellar mesoporous CMM possessing long-range order with a periodically aligned pore structure and uniform pore sizes on the mesoscale. Such materials offer high surface area and can be used as host materials to introduce additional functionality for a diverse range of applications such as adsorption, separation, catalysis, drug delivery and energy conversion and storage. In certain embodiments the exfoliated two dimensional layers of lamellar mesoporous CMM can be used to form membranes for separation for separation performance and a high degree of thermal stability.

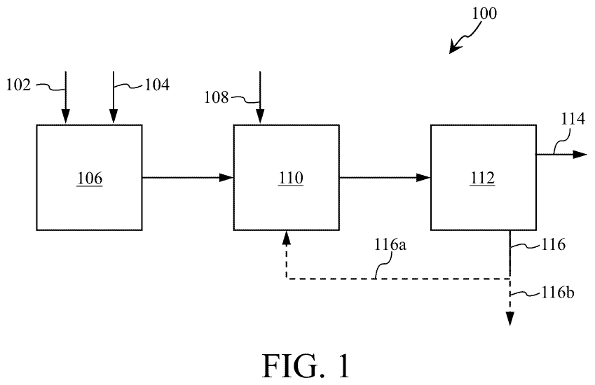

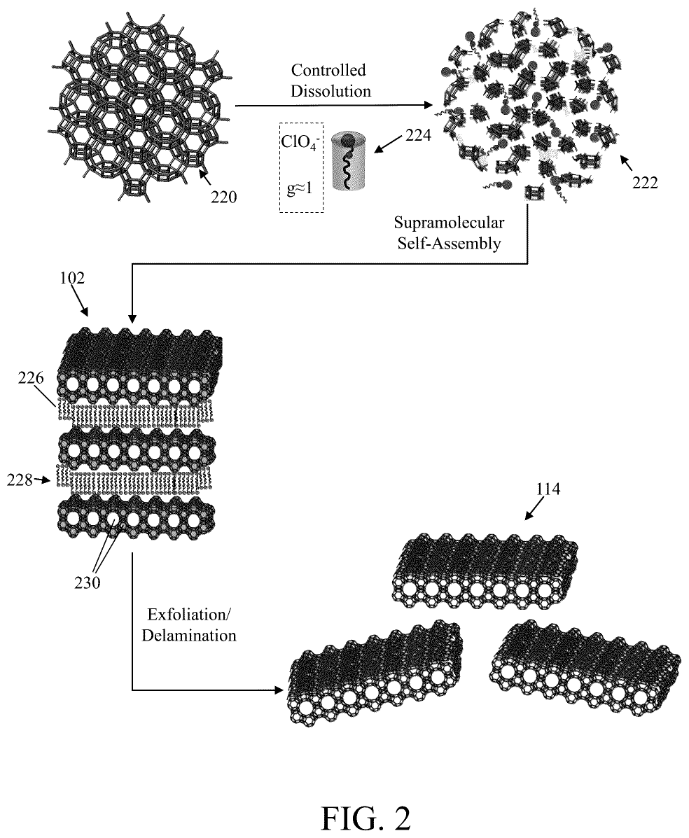

FIG. 1 is a process flow chart of a method 100 to make exfoliated or delaminated structures based on lamellar mesoporous crystalline microporous material, exfoliated LMCMM 114. In the process, lamellar mesoporous crystalline microporous material (LMCMM) 102 and exfoliating agent 104 are provided. The LMCMM 102, in the form of microporous material comprising mesopores of lamellar symmetry (for example, a lamellar zeolite) which may optionally contain supramolecular template, is dispersed in the exfoliating agent 104, shown as a dispersion step 106. To the mixture of LMCMM 102 and exfoliating agent 104 (also referred to herein as a first suspension), a solvent separation agent 108 is added, shown as a dispersion step 110. A mixture of LMCMM 102, exfoliating agent 104 and solvent separation agent 108 suspension (also referred to herein as a second suspension) is produced. The second suspension is subjected to a separation step 112 for recovery of solids as the exfoliated LMCMM 114. A supernatant, for example containing separation agent and any remaining exfoliating agent, is removed, stream 116. In certain embodiments a stream 116a (which can be all or a portion of stream 116) is recycled to step 110 (shown in dashed lines). In certain embodiments a stream 116b (which can be all or a portion of stream 116) is discharged (shown in dashed lines).

A portion of the exfoliated/delaminated layers from the LMCMM from the suspension is collected and recovered as the exfoliated LMCMM 114. Conditions during steps 106, 110 and 112 are such that the underlying microporous nature of the lamellar crystalline microporous material is retained.

Dispersion step 106 can be carried out for an effective time and under effective conditions to attain a homogeneous dispersion of the LMCMM 102 and exfoliating agent 104. Insufficient dispersion could result in undesirable products with a lesser degree of exfoliation. Dispersion step 106 is conducted at a suitable temperature, for example about 20-60, 20-50, 20-40, 20-30, 25-60, 25-50, 25-40 or 25-30° C. Dispersion step 106 occurs for a suitable time period to ensure a homogeneous dispersion, such as about 0.2-5, 0.2-3, 0.2-1, 0.5-5, 0.5-3, 0.5-1, 1-5, or 1-3 hours, for example about 1 hour. Suitable mass ratios of the LMCMM 102 to the exfoliating agent 104 include, for example, about 1:4-1:20, 1:4-1:16, 1:4-1:12, 1:6-1:20, 1:6-1:16, 1:6-1:12, 1:8-1:20, 1:8-1:16 or 1:8-1:12, for example to provide a mixture of about 5-20, 6-20, 7.5-20, 5-20, 6-20, 7.5-20, 5-18, 6-18, 7.5-12, 5-12, 6-12, 7.5-12, or about 9 mass % LMCMM 102.

In certain embodiments, dispersion step 106 comprises one or more of sonication, ultrasonication, chaotic flow, melt-compounding, shear mixing, one or more chemical deprotection process (such as breaking of Si—O and Al—O bonds in the interlayer region), base etching, or exfoliation using one or more of halides, swelling agent, and surfactants. In certain embodiments, dispersion step 106 comprises sonication or ultrasonication.

Dispersion step 110 is carried out to disperse the separation agent 108 in the mixture of the LMCMM 102 and exfoliating agent 104. Suitable mass ratios of solids from LMCMM 102 to the separation agent 108 include, for example, about 1:25-1:1000, 1:25-1:500, 1:25-1:200, 1:25-1:150, 1:50-1:1000, 1:50-1:500, 1:50-1:200 or 1:50-1:150, for example to provide a mixture of about 1 mass % solids. Dispersion step 110 occurs for a suitable time period to ensure a homogeneous dispersion, such as about 0.2-5, 0.2-4, 0.2-3, 0.2-2, 0.2-1, 0.5-5, 0.5-4, 0.5-3, 0.5-2, 0.5-1, 1-5, 1-4, 1-3, or 1-2 hours, for example about 1 hour. Separation 110 is conducted at a suitable temperature, for example about 20-60, 20-50, 20-45, 20-40, 25-60, 25-50, 25-45 or 25-40° C.

In certain embodiments, dispersion step 110 comprises one or more of sonication, ultrasonication, chaotic flow, melt-compounding or shear mixing. In certain embodiments, dispersion step 110 comprises sonication or ultrasonication.

Separation step 112 is carried out to recover exfoliated LMCMM product 114. In certain embodiments, separation step 112 includes separation by one or more of centrifugation, decanting, gravity, vacuum filtration, filter press, or rotary drum. In certain embodiments, separation step 112 includes centrifugation followed by decanting of the centrifuged LMCMM suspension for collection of the exfoliated LMCMM product 114. In certain embodiments, separation step 112 includes centrifugation, follows by decanting the top 10-50, 10-40, 10-30, 10-25, 20-50, 20-40, 20-30, 30-50, 30-40, or 40-50% of the centrifuged LMCMM suspension for collection of the exfoliated LMCMM product 114.

In certain embodiments dispersion step 110 may be repeated one or more additional times which promotes removal of 90-95, 90-99, 90-99.9, 90-100, 95-99, 95-99.9 or 95-100 w % of exfoliating agent. In embodiments in which exfoliating agent remains, one or more additional purification steps may optionally be carried out (not shown) for 100 w % removal.

In certain embodiments, dispersion step 110 is repeated two or more times, for example, 2-10, 2-5 or 2-3 times. For example, after separation of sediment from a first instance of dispersion with a first amount of separation agent 108, that sediment may be redispersed with an additional amounts of separation agent 108. This process may be repeated, wherein the final dispersion subjected to separation 112 for collection of the exfoliated LMCMM product 114.

In certain embodiments exfoliated or delaminated layers of lamellar microporous CMM include two dimensional sheets, wherein the cumulative thickness of the sheets of about 3-2000, 3-1000, 3-500, 3-100, 3-50, 3-10, 10-2000, 10-1000, 10-500, 10-100, 10-50, 20-2000, 20-1000, 20-500, 20-100, 20-50, 50-2000, 50-1000, 50-500 or 50-100 or nanometers. In certain embodiments a mixture of material is provided having a distribution of numbers of layers of lamellar microporous CMM and hence a distribution of thicknesses.

In certain embodiments density gradient separation is employed at step 110 to separate lamellar microporous CMM, for instance centrifugation using a solvent mixture, wherein sheets are separated based on thickness; a top layer of centrifuged mixture comprises sheets having a thickness in the range of about 3-100, 3-50, 10-100, 10-50 or 3-10 nanometers, and lower layers comprise sheets including those with such smaller and greater thicknesses, for example in the range of about 3-2000, 3-1000, 3-500, 3-100, 3-50, 10-2000, 10-1000, 10-500, 10-100, 10-50, 20-2000, 20-1000, 20-500, 20-100, 20-50, 50-2000, 50-1000, 50-500 or 50-100 nanometers.

In certain embodiments exfoliated or delaminated layers of lamellar FAU zeolite include the two dimensional sheets, wherein the cumulative thickness of the sheets is in the range of about 3-2000, 3-1000, 3-500, 3-100, 3-50, 3-10, 10-2000, 10-1000, 10-500, 10-100, 10-50, 20-2000, 20-1000, 20-500, 20-100, 20-50, 50-2000, 50-1000, 50-500 or 50-100 or nanometers. In certain embodiments a mixture of material is provided having a distribution of numbers of layers of lamellar FAU zeolite and hence a distribution of thicknesses.

In certain embodiments density gradient separation is employed at step 110 to separate lamellar FAU, for instance centrifugation using a solvent mixture, wherein sheets are separated based on thickness; a top layer of centrifuged mixture comprises sheets having a thickness in the range of about 3-100, 3-50, 10-100, 10-50 or 3-10 nanometers, and lower layers comprise sheets including those with such smaller and greater thicknesses, for example in the range of about 3-2000, 3-1000, 3-500, 3-100, 3-50, 10-2000, 10-1000, 10-500, 10-100, 10-50, 20-2000, 20-1000, 20-500, 20-100, 20-50, 50-2000, 50-1000, 50-500 or 50-100 nanometers.

In certain embodiments, the exfoliating agent 104 comprises polystyrene, polybutadiene, polylactic acid, polyvinylpyrrolidone, polyethyleneimine or combinations comprising one or more of the foregoing polymers. In certain embodiments, the exfoliating agent 104 comprises a polybutadiene source. In certain embodiments, the exfoliating agent 104 in the form of a polybutadiene source comprises hydroxyl-terminated polybutadiene (HTPB), carboxyl-terminated polybutadiene (CTPB), polybutadiene, or combinations comprising one or more of the foregoing polybutadiene sources.

In certain embodiment, the solvent separation agent 108 is used for separation and purification. In certain embodiment, the solvent separation agent 108 is one or more solvents including toluene, dichloromethane (DCM), chloroform, n-octanol, chlorobenzene, chloromethane, or combinations comprising one or more of the foregoing solvents.

The LMCMM 102 is in the form of microporous material comprising mesopores of lamellar symmetry (for example, a lamellar zeolite). In certain embodiments the LMCMM 102 is in the form of microporous material comprising mesopores of lamellar symmetry (for example, a lamellar zeolite) and with supramolecular template formed into shaped micelles retained between layers.

In certain embodiments, lamellar symmetry of the LMCMM 102 is primarily observed in the as-made materials (that is, prior to calcination and with supramolecular template formed into shaped micelles retained between layers). In the absence of CMM interconnections between lamellar structures, there is a tendency to collapse during calcination.

Synthetic strategies to produce the LMCMM 102, for example hierarchical zeolites, include bottom-up approaches which involve the use of hard templates and soft templates, and top-down approaches which typically involve post-synthetic treatment. Bottom-up strategies generally involve templating techniques used in situ during crystallization of the CMM, for example using hard templates (carbon sources) or soft templates (surfactants). Top-down strategies generally involve post-synthetic modifications of already formed CMM such as zeolites, for example, by steaming, dealumination (using an acid) or desilication (using a base). In certain embodiments herein, the LMCMM 102 is obtained by bottom-up strategies. In certain embodiments herein, the LMCMM 102 is obtained by top-down strategies.

FIG. 2 is an embodiment of a method to obtain exfoliated LMCMM 114, including steps to synthesize LMCMM 102. The method shown in FIG. 2 is based on a hierarchical ordering by post-synthetic ensembles synthesis route, including the general synthesis mechanism and influence of the anionic Hofmeister effect (AHE) on the g values to alter the micellar curvature and induce mesophase transition. Generally, a method to make LMCMM 102 includes base-mediated dissolution/incision of parent CMM into oligomeric components, and reorganization into hierarchically ordered mesostructures by supramolecular templating, and in certain embodiments by the Hofmeister effect. The CMM schematically depicted in FIG. 2 is FAU zeolite. Although not shown, other CMM can be utilized as a parent CMM to form LMCMM 102 used in the methods herein by the post-synthetic ensembles synthesis route.

According to the method shown in FIG. 2, a parent CMM 220 is provided in crystalline form. An effective amount of an alkaline reagent and an effective amount of a surfactant for supramolecular templating, supramolecular template 224, are added to form an aqueous suspension, and that suspension is maintained under hydrothermal conditions to form oligomeric CMM units 222 of the parent CMM (such as oligomeric zeolitic units when the parent CMM is zeolite). The molecules of the supramolecular template 224 form into shaped micelles 226 and oligomeric CMM units hierarchically reassemble and crystallize around the shaped micelles as an ordered mesostructure. This supramolecular self-assembly results in formation of hierarchically ordered lamellar mesoporous CMM 102, having mesopores 228 of defined symmetry and mesopore walls formed of the oligomeric CMM units thereby retaining micropores 230 of the underlying CMM structure of the parent CMM.

In certain embodiments, an ionic co-solute is employed. In certain embodiments, an ionic co-solute comprises a perchlorate (as shown in dashed lines together with the supramolecular template 224). A general synthesis mechanism includes ion-specific interactions, that is, anionic Hofmeister effect (AHE), on g values and concomitantly the micellar curvature and the induced mesophase transition. In certain embodiments, a perchlorate is used as an ionic co-solute, the micellar curvature is represented by a surfactant packing parameter g in the range of about 1, and the resulting hierarchically ordered lamellar mesoporous CMM possesses long-range mesoporous ordering of lamellar symmetry. Ion-specific interactions (the Hofmeister effect) on the micellar curvature in a self-assembly process are apparent. Anions of different sizes and charges possess different polarizabilities, charge densities and hydration energies in aqueous solutions. When paired with a positive surfactant head group, these properties can affect the electrostatic repulsions among the head groups and hydration at the micellar interface, thus changing the area of the head group (a₀). Such short-range ion-specific interactions can be a significant driving force in changing the micellar curvature and inducing mesophase transition. Based on the Hofmeister series (SO₄²⁻>HPO₄²⁻>oAc⁻>Cl⁻>Br⁻>NO₃⁻>ClO₄⁻>SCN⁻), the strongly hydrated ions (left side of series) can increase the micellar curvature, whereas weakly hydrated ions can decrease the micellar curvature. In certain embodiments, ClO₄⁻ is selected as an ionic co-solute to induce lamellar formation.

An effective amount of a solvent is used in the process. In certain embodiments the solvent is water. In certain embodiments the solvent is water in the presence of co-solvents selected from the group consisting of polar solvents, non-polar solvents and pore swelling agents (such as 1,3,5-trimethylbenzene). In certain embodiments the solvent selected from the group consisting of polar solvents, non-polar solvents and pore swelling agents (such as 1,3,5-trimethylbenzene), in the absence of water. In an embodiment, mixture components are added with water to the reaction vessel prior to heating. Typically, water allows for adequate mixing to realize a more homogeneous distribution of the suspension components, which ultimately produces a more desirable product because each crystal is more closely matched in properties to the next crystal. Insufficient mixing could result in undesirable products with respect to amorphous phases or a lesser degree of long-range order.

The suspension components are combined in any suitable sequence and are sufficiently mixed to form a homogeneous distribution of the suspension components. The suspension can be maintained in an autoclave under autogenous pressure (from the components or from the components plus an addition of a gas purge into the vessel prior to heating), or in another suitable vessel, under agitation such as by stirring, tumbling and/or shaking. Mixing of the suspension components is conducted between about 20-60, 20-50 or 20-40° C.

The steps of incision and reassembly occur during hydrothermal treatment to form a solid product (hierarchically ordered lamellar mesoporous CMM having well-defined long-range mesoporous ordering of two dimensional lamellar symmetry) suspended in a supernatant (mother liquor). In certain embodiments for synthesis of LMCMM 102 herein, hydrothermal treatment is conducted: for a period of about 4-168, 12-168, 24-168, 4-96, 12-96 or 24-96 hours; at a temperature of about 70-250, 70-210, 70-180, 70-150, 90-250, 90-210, 90-180, 90-150, 110-250, 110-210, 110-180 or 110-150° C.; and at a pressure of about atmospheric to autogenous pressure. In certain embodiments for synthesis of LMCMM 102 herein hydrothermal treatment occurs in a vessel that is the same as that used for mixing, or the suspension is transferred to another vessel (such as another autoclave or low-pressure vessel). In certain embodiments the vessel used for hydrothermal treatment for synthesis of LMCMM 102 herein is static. In certain embodiments the vessel used for hydrothermal treatment for synthesis of LMCMM 102 herein is under agitation that is sufficient to suspend the components. The solids are recovered using known techniques such as centrifugation, decanting, gravity, vacuum filtration, filter press, or rotary drums. The recovered material is dried, for example at a temperature of about 50-150, 50-120, 80-150 or 80-120° C., at atmospheric pressure or under vacuum conditions, for a time of about 0.5-96, 12-96 or 24-96 hours, and hierarchically ordered lamellar mesoporous CMM 102 is recovered.

In certain embodiments of reassembly to produce the LMCMM 102: the rate and extent of CMM dissolution is controlled by employing urea as an in situ base, and by mediating hydrothermal temperature to control urea hydrolysis and fine-tune pH of the solution; extent of dissolution into smaller oligomers is controlled by the surfactant-CMM interactions during the initial stages of dissolution, whereby influence of the ion-specific interactions, that is, anionic Hofmeister effect (AHE) on supramolecular self-assembly directs formation of hierarchically ordered structures lamellar symmetry; in certain embodiments the hierarchically ordered structures possess lamellar p2 symmetry.

According to certain embodiments to produce the LMCMM 102, a parent CMM is formed into an aqueous suspension with an alkaline reagent and a supramolecular templating agent. In additional embodiments, the aqueous suspension includes an ionic co-solute as an additional anion that is separate from the anion which is paired with the cation of the supramolecular template. The system is maintained under conditions to induce incision of the parent CMM into oligomeric units of the CMM, with only a minor portion of monomeric units, and to induce hierarchical reassembly of the oligomeric units into mesostructures. System conditions (including temperature and time of crystallization), selection and concentration of supramolecular template, and selection and concentration of alkaline reagent are tailored to control incision of the parent CMM into oligomeric units and to control reassembly of those oligomeric units around the shape(s) of supramolecular template micelles. Dissolution of parent CMM is encouraged to the extent of oligomer formation while minimizing monomer formation, which is controlled by selection of supramolecular template, alkaline reagent, optional ionic co-solute and hydrothermal conditions (including temperature and time). In certain embodiments, a substantial portion, a significant portion or a major portion of the parent CMM is cleaved into oligomeric units, with any remainder in the form of monomeric units or atomic constituents of the CMM. In certain embodiments, dimensions of the oligomeric units correspond approximately to the wall thickness of the synthesized mesoporous structure, the LMCMM 102. In certain embodiments interface curvature(s) of the micelles and oligomeric units under reassembly is tuned to a desired mesostructure and mesoporosity with the aid of optional ionic co-solute and the Hofmeister effect.

Under effective crystallization conditions and time, and using effective type(s) of supramolecular template and alkaline reagent at effective relative concentrations, hierarchical ordering by post-synthetic ensembles occurs: the parent CMM is incised into oligomeric CMM units that rearrange around the shaped micelles formed by the supramolecular templates. The LMCMM 102 thus synthesized are hierarchically ordered CMM having well-defined long-range mesoporous ordering are formed by the supramolecular templating method using the surfactant micelles. The mesopore walls are characterized by the parent CMM. The effective supramolecular templates include those having one or more properties forming a dimension that blocks all, a substantial portion, a significant portion or a major portion of the supramolecular template molecules from entering pores, channels and/or cavities of the parent CMM. These methods disclosed herein effectuate base-mediated incisions of the CMM crystals, in the presence of the supramolecular template of the type/characteristic disclosed herein, into oligomeric components, with subsequent reorganization around well-defined micelles by supramolecular templating, into hierarchically ordered structures having a well-defined long-range lamellar mesoporous ordering.

The curvature or shape of the micelles results in the final lamellar mesophase symmetry of the LMCMM 102. Formation of the supramolecular template molecules into micelles is dependent upon factors such as the supramolecular template type, supramolecular template concentration, presence or absence of an ionic co-solute, CMM type(s), crystallization temperature, type of alkaline reagent, concentration of alkaline reagent, pH level of the system, and/or presence or absence of other reagents. In general, at low concentrations supramolecular templates exist as discrete entities. At higher concentrations, that is, above a critical micelle concentration (CMC), micelles are formed. The hydrophobic interactions in the system including the supramolecular template alters the packing shape of the supramolecular templates into, for example, spherical, prolate or cylindrical micelles, which can thereafter form thermodynamically stable two-dimensional or three-dimensional liquid crystalline phases of ordered mesostructures (see, for example, FIG. 1.4 of Zana, R. (Ed.). (2005). Dynamics of Surfactant Self-Assemblies: Micelles, Microemulsions, Vesicles and Lyotropic Phases (1^{st} ed.). CRC Press, Chapter 1, which shows self-assembly based on surfactant and surfactant packing parameter).

In certain embodiments of synthesis of the LMCMM 102, the Hofmeister series (HS), ion specific effect, or lyotropic sequence is followed for selection of supramolecular templates and/or ionic co-solute to control curvature or shape (e.g., spherical, ellipsoid, cylindrical, or unilamellar structures) of the micelles (see, for example, Beibei Kang, Huicheng Tang, Zengdian Zhao, and Shasha Song. “Hofmeister Series: Insights of Ion Specificity from Amphiphilic Assembly and Interface Property” ACS Omega 5 (2020): 6229-6239). In embodiments of the methods for synthesis of hierarchically ordered microporous crystalline materials having well-defined long-range mesoporous ordering disclosed herein, mesophase transitions of hierarchical ensembles yield distinct mesostructures based on the anionic Hofmeister effect and supramolecular self-assembly. Anions of different sizes and charges possess different polarizabilities, charge densities and hydration energies in aqueous solutions. When paired with a positive supramolecular template head group, these properties can affect the short-range electrostatic repulsions among the head groups and hydration at the micellar interface, thus changing the area of the head group (a₀). Such ion-specific interactions can be a driving force in changing the micellar curvature and inducing mesophase transition. Based on the HS (SO₄²⁻>HPO₄²⁻>oAc⁻>Cl >Br⁻>NO₃⁻>ClO₄⁻>SCN), strongly hydrated ions (left side of the HS) can increase the micellar curvature, whereas weakly hydrated ions can decrease the micellar curvature. In certain embodiments, ClO₄⁻ is selected as an ionic co-solute to induce lamellar formation. A surfactant packing parameter, g=V/a₀l (V=total volume of surfactant tails, a₀=area of the head group, l=length of surfactant tail), can be used to describe these mesophase transitions.

In the methods for synthesis of LMCMM 102 in the form of hierarchically ordered LMCMM having well-defined long-range mesoporous ordering, suitable alkaline reagents include one or more basic compounds to maintain the system at a pH level of greater than about 8. In certain embodiments the alkaline reagent is provided at a concentration in the aqueous suspension of about 0.1-2.0 M. In certain embodiments the alkaline reagent is provided at a concentration in the aqueous suspension of about 0.1-5 mass %. In certain embodiments the alkaline reagent comprises urea. In certain embodiments the alkaline reagent comprises ammonia. In certain embodiments the alkaline reagent comprises ammonium hydroxide. In certain embodiments the alkaline reagent comprises sodium hydroxide. In certain embodiments the alkaline reagent comprises alkali metal hydroxides including hydroxides of sodium, lithium, potassium, rubidium, or cesium.

In certain embodiments for synthesis of LMCMM 102, the alkaline reagent is effective to enable controlled hydrolysis; for example, urea can be used as an alkaline agent, and during hydrolysis urea reacts to form ammonium hydroxide. In such embodiments, pH is increased relatively slowly to a maximum pH as a function of time, which is beneficial to the process, rather than adding an amount of another alkaline reagent such as ammonium hydroxide in the initial solution to the maximum pH. In certain embodiments for synthesis of LMCMM 102, the alkaline reagent comprises alkylammonium cations, having the general formula R_{X}H_{4-X}N⁺[A], wherein at X=1-4 and R₁, R₂, R₃ and R₄ can be the same or different C1-C30 alkyl groups, and wherein [A] is a counter anion can be OH⁻, Br⁻, Cl⁻ or I⁻. In certain embodiments the alkaline reagent comprises quaternary ammonium cations with alkoxysilyl groups, phosphonium groups, an alkyl group with a bulkier substituent or an alkoxyl group with a bulkier substituent. In certain embodiments the alkylammonium cations used in this regard function as a base rather than as a surfactant or template. In certain embodiments for synthesis of LMCMM 102 using ammonia, ammonium hydroxide or alkali metal hydroxides, amorphous material is also present with the crystalline material in the product. In certain embodiments for synthesis of LMCMM 102, by the controlled hydrolysis of urea to ammonium hydroxide there is a reduction in the amount of apparent amorphous material present in the reaction products (for example an overall broad band at 25° (2θ) in XRD), when compared with alternative routes such as NaOH or directly with ammonium hydroxide.

In certain embodiments for synthesis of LMCMM 102 in the form of hierarchically ordered LMCMM having well-defined long-range mesoporous ordering disclosed herein, suitable surfactants as supramolecular templates are provided to assist the reassembly and recrystallization of dissolved components (oligomers) by covalent and/or electrovalent interactions. Supramolecular templates are provided at a concentration in the aqueous suspension of about 0.01-0.5 M. In certain embodiments suitable supramolecular templates are provided at a concentration in the aqueous suspension of about 0.5-10 mass %. Suitable supramolecular templates are characterized by constrained diffusion within the micropore channels of parent CMM, referred to as bulky surfactants or bulky supramolecular templates. Diffusion of supramolecular template molecules into micropore-channels or cavities encourages CMM dissolution. This is minimized in the top-down methods for synthesis of hierarchically ordered CMM having well-defined long-range mesoporous ordering disclosed herein, wherein effective supramolecular templates minimize diffusion or partial diffusion thereof into CMM pore-channels, cavities or window openings. Such supramolecular templates possess suitable dimensions to block such diffusion. The suitable dimensions can be based on dimensions of a head group and/or a tail group of a supramolecular template. In certain embodiments suitable dimensions can be based on a co-template having one or more components with suitable head and/or tail groups, or being a template system arranged in such a way, so as to minimize or block diffusion in to CMM pore-channels, cavities or window openings. By minimizing diffusion of templates into the CMM pore channels, CMM dissolution into oligomers and comprehensive reorganization and assembly into the hierarchically ordered CMM having well-defined long-range mesoporous ordering disclosed herein is encouraged. In certain embodiments, a supramolecular template is one in which at least a substantial portion, a significant portion or a major portion of the surfactant does not enter into pores and/or channels of the CMM. For example, organosilanes (˜0.7 nm) are relatively large compared to quaternary ammonium surfactants without such bulky groups including cetyltrimethylammonium bromide (CTAB) (˜0.25 nm). In certain embodiments, a supramolecular template contains a long chain linear group (>˜0.6 nm). In certain embodiments, a supramolecular template contains an aromatic or aromatic derivative group (>˜0.6 nm). In certain embodiments, supramolecular templates contain one or more bulky groups having a dimension based on modeling of molecular dimensions as a cuboid having dimensions A, B and C, using Van der Waals radii for individual atoms, wherein one or more, two or more, or all three of the dimensions A, B and C are sufficiently close in dimension, or sufficiently larger in dimension, that constrains diffusion into the micropores of the selected parent CMM.

In certain embodiments for synthesis of LMCMM 102, an effective surfactant as a supramolecular template contains at least one moiety, as a head group or a tail group, selected from the group consisting of organosilanes, hydroxysilyls, alkoxysilyls, aromatics, branched alkyls, sulfonates, carboxylates, phosphates and combinations comprising one of the foregoing moieties. In certain embodiments an effective supramolecular template is an organosilane that contains at least one hydroxysilyl as a head group moiety. In certain embodiments an effective supramolecular template is an organosilane that contains at least one hydroxysilyl as a tail group moiety. In certain embodiments an effective supramolecular template is an organosilane that contains at least one alkoxysilyl as a head group moiety. In certain embodiments an effective supramolecular template is an organosilane that contains at least one alkoxysilyl as a tail group moiety. In certain embodiments an effective supramolecular template contains at least one aromatic as a head group moiety. In certain embodiments an effective supramolecular template contains at least one aromatic as a tail group moiety. In certain embodiments an effective supramolecular template contains at least one branched alkyl as a head group moiety. In certain embodiments an effective supramolecular template contains at least one branched alkyl as a tail group moiety. In certain embodiments an effective supramolecular template contains at least one sulfonate as a head group moiety. In certain embodiments an effective supramolecular template contains at least one sulfonate as a tail group moiety. In certain embodiments an effective supramolecular template contains at least one carboxylate as a head group moiety. In certain embodiments an effective supramolecular template contains at least one carboxylate as a tail group moiety. In certain embodiments an effective supramolecular template contains at least one phosphate as a head group moiety. In certain embodiments an effective supramolecular template contains at least one phosphate as a tail group moiety. These moieties are characterized by one or more dimensions that constrain diffusion into pores of a parent CMM. In certain embodiments, in which the CMM is characterized by pores of various dimensions, the selected moieties are characterized by one or more dimensions that constrain diffusion into the largest pores the parent CMM.

In certain embodiments for synthesis of LMCMM 102, an effective supramolecular template contains at least one cationic moiety. In certain embodiments an effective supramolecular template contains at least one cationic moiety selected from the group consisting of a quaternary ammonium moiety and a phosphonium moiety. In certain embodiments an effective supramolecular template contains at least one quaternary ammonium group having a terminal alkyl group with 6-24 carbon atoms. In certain embodiments an effective supramolecular template contains two quaternary ammonium groups wherein an alkyl group bridging the quaternary ammonium groups contains 1-10 carbon atoms. In certain embodiments an effective supramolecular template contains at least one quaternary ammonium group, and at least one constituent group, a head group moiety as described above. In certain embodiments an effective supramolecular template contains at least one quaternary ammonium group, and at least one constituent group, a tail group moiety as described above. In certain embodiments an effective supramolecular template contains at least one quaternary ammonium group, at least one constituent group, a head group moiety as described above, and an alkyl group that contains 1-10 carbon atoms bridging at least one of the quaternary ammonium groups and at least one of the head groups. In certain embodiments an effective supramolecular template contains at least one quaternary ammonium group, at least one constituent group, a tail group moiety as described above, and an alkyl group that contains 1-10 carbon atoms bridging at least one of the quaternary ammonium groups and at least one of the tail groups.

In certain embodiments for synthesis of LMCMM 102, an effective supramolecular template comprises a quaternary ammonium compound and a constituent group comprising one or more bulky organosilane or alkoxysilyl substituents. In certain embodiments an effective supramolecular template comprises a quaternary ammonium compound and a constituent group comprising one or more long-chain organosilane or alkoxysilyl substituents. In certain embodiments an effective supramolecular template cation comprises dimethyloctadecyl(3-trimethoxysilyl-propyl)-ammonium or derivatives of dimethyloctadecyl(3-trimethoxysilyl-propyl)-ammonium. In certain embodiments an effective supramolecular template cation comprises dimethylhexadecyl(3-trimethoxysilyl-propyl)-ammonium or derivatives of dimethylhexadecyl(3-trimethoxysilyl-propyl)-ammonium. In certain embodiments an effective supramolecular template cation comprises a double-acyloxy amphiphilic organosilane such as [2,3-bis(dodecanoyloxy)-propyl] (3-(trimethoxysilyl) propyl)-dimethylammonium or derivatives of [2,3-bis(dodecanoyloxy)-propyl] (3-(trimethoxysilyl) propyl)-dimethylammonium.

In certain embodiments for synthesis of LMCMM 102, an effective supramolecular template comprises a quaternary phosphonium compound and a constituent group comprising one or more bulky aromatic substituents. In certain embodiments an effective supramolecular template comprises a quaternary phosphonium compound and a constituent group comprising one or more bulky alkoxysilyl or organosilane substituents.

In certain embodiments for synthesis of LMCMM 102, an effective supramolecular template contains a tail group moiety selected from the group consisting of aromatic groups containing 6-50, 6-25, 10-50 or 10-25 carbon atoms, alkyl groups containing 1-50, 1-25, 5-50, 5-25, 10-50 or 10-25 carbon atoms, aryl groups containing 1-50, 1-25, 5-50, 5-25, 10-50 or 10-25 carbon atoms, or a combination of aromatic and alkyl groups having up to 50 carbon atoms. In certain embodiments an effective supramolecular template contains a head group moiety selected from the group consisting of aromatic groups containing 6-50, 6-25, 10-50 or 10-25 carbon atoms, alkyl groups containing 1-50, 1-25, 5-50, 5-25, 10-50 or 10-25 carbon atoms, aryl groups containing 1-50, 1-25, 5-50, 5-25, 10-50 or 10-25 carbon atoms, or a combination of aromatic and alkyl groups having up to 50 carbon atoms. In certain embodiments an effective supramolecular template contains co-templated agents selected from the group consisting of quaternary ammonium compounds (including for example quaternary alkyl ammonium cationic species) and quaternary phosphonium compounds.

In certain embodiments for synthesis of LMCMM 102, effective supramolecular templates comprise (a) at least one of: aromatic quaternary ammonium compounds, branched alkyl chain quaternary ammonium compounds, alkyl benzene sulfonates, alkyl benzene phosphonates, alkyl benzene carboxylates, or substituted phosphonium cations; and (b1) and a constituent group comprising at least one of organosilanes, hydroxysilyls, alkoxysilyls, aromatics, branched alkyls, sulfonates, carboxylates or phosphates, as a head group; or (b2) and a constituent group comprising at least one of organosilanes, hydroxysilyls, alkoxysilyls, aromatics, branched alkyls, sulfonates, carboxylates or phosphates, as a tail group. In certain embodiments effective supramolecular templates include a sulfonate group (a non-limiting example is sulfonated bis(2-hydroxy-5-dodecylphenyl) methane (SBHDM)). In certain embodiments effective supramolecular templates include a carboxylate group (a non-limiting example is sodium 4-(octyloxy)benzoate). In certain embodiments effective supramolecular templates include a phosphonate group (a non-limiting example is tetradecyl(1,4-benzene)bisphosphonate). In certain embodiments effective supramolecular templates include an aromatic group (a non-limiting example is benzylcetyldimethylammonium chloride). In certain embodiments effective supramolecular templates include an aliphatic group (a non-limiting example is tetraoctylammonium chloride).

The supramolecular template used in certain embodiments for synthesis of LMCMM 102 is provided as a cation/anion pair. In certain embodiments a cation of a supramolecular template is as described above is paired with an anion selected such as Cl⁻, Br⁻, OH⁻, F⁻ and I⁻. In certain embodiments a cation of a supramolecular template is as described above is paired with an anion such as Cl⁻, Br⁻ or OH⁻. In certain embodiments an effective supramolecular template comprises dimethyloctadecyl [3-(trimethoxysilyl) propyl] ammonium chloride (commonly abbreviated as “TPOAC”) or derivatives of dimethyloctadecyl [3-(trimethoxysilyl) propyl] ammonium chloride.

In certain embodiments an effective supramolecular template comprises dimethylhexadecyl [3-(trimethoxysilyl) propyl] ammonium chloride or derivatives of dimethylhexadecyl [3-(trimethoxysilyl) propyl] ammonium chloride. In certain embodiments an effective supramolecular template comprises [2,3-bis(dodecanoyloxy)-propyl] (3-(trimethoxysilyl) propyl)-dimethylammonium iodide or derivatives of [2,3-bis(dodecanoyloxy)-propyl] (3-(trimethoxysilyl) propyl)-dimethylammonium iodide.

In certain embodiments for synthesis of LMCMM 102, an effective amount of an ionic co-solute (that is, in addition to the anion paired with the supramolecular template). In certain embodiments in which an ionic co-solute is used it is provided at a concentration in the aqueous suspension of about 0.01-0.5 M. In certain embodiments in which an ionic co-solute is used it is provided at a concentration in the aqueous suspension of about 0.01-5 mass %. In certain embodiments an ionic co-solute is selected from the group consisting of CO₃²⁻, SO₄²⁻, S₂O₃²⁻, H₂PO₄⁻, F⁻, Cl⁻, Br⁻, NO₃⁻, I⁻, ClO₄⁻, SCN⁻ and C₆H₅O₈⁻³ (citrate). In certain embodiment an ionic co-solute is selected based on the Hofmeister series/Lyotropic series to control the curvature/shape of the micelles to yield the desired lamellar mesophase symmetry. In certain embodiments a perchlorate (ClO₄⁻) is an ionic co-solute selected based on the Hofmeister series/Lyotropic series to control the curvature/shape of the micelles to yield hierarchically ordered LMCMM having well-defined long-range mesoporous ordering possess a lamellar mesophase symmetry; in certain embodiments using perchlorate as an ionic co-solute, a perchlorate salt is used, such as sodium perchlorate, or another metal perchlorate, wherein the metal can be an alkali metal, an alkali earth metal, a transition metal, a noble metal or a rare earth metal.

In certain embodiments, long-range ordering of the of LMCMM 102 is defined by presence of secondary peaks in an x-ray diffraction pattern and/or lamellar symmetry observable by microscopy. These peaks associated with the mesoporous traits of the products are observed at low 2θ angles. The material also exhibits high-angle peaks associated with the zeolites and are observed at high 2-theta angles. In certain embodiments the low-angle peaks refer to those occurring at 2θ angles less than about 6°. In certain embodiments herein, long-range ordering of the LMCMM 102 is characterized by the mesopore periodicity repeating over a length of greater than about 50 nm.

In embodiments herein, the LMCMM 102 are characterized by lamellar mesoporous channel directions with CMM micropore channels in the walls of the mesostructure. In these embodiments CMM structures are arranged in a lamellar symmetry on the meso-scale, where the CMM particles (regardless of their atomic-level symmetry or structure) are arranged around micelles (on the meso-scale), and whereby the micelles are arranged exhibiting lamellar symmetry.

In certain embodiments lamellar symmetry of the LMCMM 102 is p2, p1 or pm symmetry. In certain embodiments lamellar symmetry of the LMCMM 102 is p2 symmetry with a secondary XRD peak associated with the periodic arrangement of mesopores present at least at the (200) reflection. In certain embodiments the high-degree of long-range lamellar mesophase ordering of the LMCMM 102 is observable by microscopy viewed by the electron beam in parallel or perpendicular directions to the zone axis. Accordingly, of the LMCMM 102 possesses a lamellar mesophase including CMM characterized by atomic-level symmetry and possessing micropores that are inherent to that type of CMM, arranged in a lamellar symmetry at the meso-scale level with mesopores, wherein walls of the mesopores and a mass of the mesostructure between mesopores is characterized by said CMM. This is created by forming oligomers of the underlying CMM and arranging those oligomers arranged around micelles exhibiting lamellar symmetry on the meso-scale. In one embodiment LMCMM 102 is provided including MFI zeolite having atomic-level orthorhombic symmetry arranged in a lamellar symmetry meso-scale, wherein during synthesis of hierarchically ordered zeolite from parent MFI zeolite, oligomers of the parent MFI zeolite are formed and arranged around micelles exhibiting lamellar symmetry on the meso-scale. In one embodiment LMCMM 102 is provided including CHA zeolite having atomic-level trigonal symmetry arranged in a lamellar symmetry meso-scale, wherein during synthesis of hierarchically ordered zeolite from parent CHA zeolite, oligomers of the parent CHA zeolite are formed and arranged around micelles exhibiting lamellar symmetry on the meso-scale. In one embodiment LMCMM 102 is provided including BEA zeolite having atomic-level tetragonal symmetry arranged in a lamellar symmetry meso-scale, wherein during synthesis of hierarchically ordered zeolite from parent BEA zeolite, oligomers of the parent BEA zeolite are formed and arranged around micelles exhibiting lamellar symmetry on the meso-scale. In one embodiment LMCMM 102 is provided including MWW zeolite having atomic-level hexagonal symmetry arranged in a lamellar symmetry meso-scale, wherein during synthesis of hierarchically ordered zeolite from parent MWW zeolite, oligomers of the parent MWW zeolite are formed and arranged around micelles exhibiting lamellar symmetry on the meso-scale. In one embodiment LMCMM 102 is provided including FAU zeolite having atomic-level cubic symmetry arranged in a lamellar symmetry meso-scale, wherein during synthesis of hierarchically ordered zeolite from parent FAU zeolite, oligomers of the parent FAU zeolite are formed and arranged around micelles exhibiting lamellar symmetry on the meso-scale.

In certain embodiments, at least a portion of the mesopores of the LMCMM 102 contain micelles of supramolecular templates shaped to induce mesoporous ordering of lamellar symmetry, and wherein the supramolecular templates possess one or more dimensions larger than dimensions of micropores of the crystalline microporous material to constrain diffusion into micropores of the crystalline microporous material. The dimensions relate to a head group of a supramolecular template, a tail group of a supramolecular template, or a co-template arrangement that constrain diffusion into micropores of the CMM. The LMCMM 102 in such embodiments are synthesized using by base-mediated reassembly, by dissolution of the parent CMM to the level of structural building units that are oligomers of the parent CMM, and minimizing or avoiding amorphization/structural collapse. The CMM dissolution and self-assembly is comprehensively controlled to produce hierarchically ordered CMM according to embodiments herein having mesoporous ordering of lamellar symmetry, including embodiments with the use of an ionic co-solute.

In certain embodiments, the supernatant remaining after LMCMM 102 is recovered, and all or a portion thereof is reused as all or a portion of the solution in a subsequent process for synthesis of additional LMCMM 102 (recovered supernatant used in subsequent process is referred to as supernatant from a prior synthesis). In certain embodiments a new synthesis can occur using supernatant from a prior synthesis together with parent CMM. In certain embodiments a new synthesis can occur using supernatant from a prior synthesis together with parent CMM and an additional quantity of make-up alkaline reagent (for example urea). In certain embodiments a new synthesis can occur using supernatant from a prior synthesis together with parent CMM and an additional quantity of make-up supramolecular template. In certain embodiments a new synthesis can occur using supernatant from a prior synthesis together with parent CMM and an additional quantity of make-up ionic co-solute. In certain embodiments a new synthesis can occur using supernatant from a prior synthesis together with parent CMM and an additional quantity of make-up alkaline reagent (for example urea) and/or make-up supramolecular template and/or optional make-up ionic co-solute.

The present disclosure is applicable to various types of CMMs as a parent material for synthesis of LMCMM 102, including zeolite or zeolite-type materials. In certain embodiments a parent CMM exhibits both good crystallinity and Al-distribution to obtain high-quality hierarchically ordered LMCMM while minimizing composite phases and/or impurities.

Suitable zeolitic materials as a parent CMM for synthesis of LMCMM 102 include those identified by the International Zeolite Association (IZA), including those with the identifiers ABW, ACO, AEI, AEL, AEN, AET, AFG, AFI, AFN, AFO, AFR, AFS, AFT, AFV, AFX, AFY, AHT, ANA, ANO, APC, APD, AST, ASV, ATN, ATO, ATS, ATT, ATV, AVE, AVL, AWO, AWW, BCT, BEC, BIK, BOF, BOG, BOZ, BPH, BRE, BSV, CAN, CAS, CDO, CFI, CGF, CGS, CHA, -CHI, -CLO, CON, CSV, CZP, DAC, DDR, DFO, DFT, DOH, DON, EAB, EDI, EEI, EMT, EON, EPI, ERI, ESV, ETL, ETR, ETV, EUO, EWO, EWS, EZT, FAR, FAU, FER, FRA, GIS, GIU, GME, GON, GOO, HEU, IFO, IFR, -IFT, -IFU, IFW, IFY, IHW, IMF, IRN, IRR, -IRY, ISV, ITE, ITG, ITH, ITR, ITT, -ITV, ITW, IWR, IWS, IWV, IWW, JBW, JNT, JOZ, JRY, JSN, JSR, JST, JSW, KFI, LAU, LEV, LIO, -LIT, LOS, LOV, LTA, LTF, LTJ, LTL, LTN, MAR, MAZ, MEI, MEL, MEP, MER, MFI, MES, MON, MOR, MOZ, MRT, MSE, MSO, MTF, MTN, MTT, MTW, MVY, MWF, MWW, NAB, NAT, NES, NON, NPO, NPT, NSI, OBW, OFF, OKO, OSI, OSO, OWE, -PAR, PAU, PCR, PHI, PON, POR, POS, PSI, PTO, PTT, PTY, PUN, PWN, PWO, PWW, RHO, -RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, SFW, SGT, SIV, SOD, SOF, SOR, SOS, SOV, SSF, SSY, STF, STI, STT, STW, -SVR, SVV, SWY, -SYT, SZR, TER, THO, TOL, TON, TSC, TUN, UEI, UFI, UOS, UOV, UOZ, USI, UTL, UWY, VET, VFI, VNI, VSV, WEI, -WEN, YFI, YUG, ZON, *BEA, *CTH, *-EWT, *-ITN, *MRE, *PCS, *SFV, *-SSO, *STO, *-SVY and *UOE.

In certain embodiments zeolites suitable as parent CMM for synthesis of LMCMM 102 are selected from the group consisting of AEI, *BEA, CHA, FAU, MFI, MOR, LTL, LTA and MWW.

In certain embodiments a parent CMM comprises faujasite zeolites (a framework designated as FAU by the IZA) are formed by 12-ring structures having made of supercages with pore opening diameters of about 7.4 angstroms (Å) (a micropore size related to the 12-member ring when viewed along the direction of 7.4×7.4 Å) and sodalite cages with pore opening diameters of about 2.3 Å. FAU zeolites are characterized by a 3-dimensional pore structure with pores running perpendicular to each other in the x, y, and z planes. Secondary building units can be positioned at 4, 6, 6-2, 4-2, 1-4-4 or 6-6. An exemplary silica-to-alumina ratio (SAR) range for faujasite zeolite is about 2 to about 6, typically with a unit cell size (units a, b and c) in the range of about 24.25 to 24.85 A. FAU zeolites are typically considered X-type when the SAR is at about 2-3, and Y-type when the SAR is greater than about 3, for instance about 3-6.

In certain embodiments a parent CMM comprises MFI framework zeolite (for example, including ZSM-5), for example having a micropore size related to the 10-member rings when viewed along the and directions of 5.5×5.1 Å and 5.6×5.3 Å, respectively.

In certain embodiments a parent CMM comprises mordenite zeolites (a framework designated as MOR by the IZA), for example having a micropore size related to the 12-member ring and 8-member ring when viewed along the and directions of 6.5×7.0 Å and 2.6×5.7 Å, respectively.

In certain embodiments a parent CMM comprises beta zeolite or zeolite beta polymorph A (a framework designated as *BEA by the IZA), for example having a micropore size related to the 12-member rings when viewed along the and directions of 6.6×6.7 Å and 5.6×5.6 Å, respectively.

In certain embodiments a parent CMM comprises chabazite zeolite (a framework designated as CHA by the IZA), for example having a micropore size related to the 8-member ring when viewed normal to the direction of 3.8×3.8 Å.

In certain embodiments a parent CMM comprises Linde Type L zeolite (zeolite L) (a framework designated as LTL by the IZA), for example having a micropore size related to the 12-member ring when viewed along the direction of 7.1×7.1 Å.

In certain embodiments a parent CMM comprises Linde Type A zeolite (zeolite A) (a framework designated as LTL by the IZA), for example having a micropore size related to the 8-member ring when viewed along the direction of 4.1×4.1 Å.

In certain embodiments a parent CMM comprises zeolite having a framework designated as AEI by the IZA, for example having a micropore size related to the 8-member ring when viewed normal to the direction of 3.8×3.8 Å.

In certain embodiments a parent CMM comprises zeolite having a framework designated as MWW by the IZA, including MCM-22, for example having a micropore size related to the 10-member rings when viewed normal to direction “between layers” and “within layers” of 4.0×5.5 Å and 4.1×5.1 Å, respectively.

In certain embodiments a parent CMM is a zeolite-type material, for example, aluminophosphates (AIPO), silicon-substituted aluminophosphates (SAPO), or metal-containing aluminophosphates (MAPO). In certain embodiments a parent CMM is a zeolitic siliceous only framework material.

As described above, embodiments herein include supramolecular templates that contain one or more bulky groups having a dimension based on modeling of molecular dimensions as a cuboid having dimensions A, B and C, using Van der Waals radii for individual atoms, wherein one or more, two or more, or all three of the dimensions A, B and C are sufficiently close in dimension, or sufficiently larger in dimension, that constrains diffusion into the micropores of the CMM. Also as described above with respect to the known parameters related to pore dimensions for exemplary zeolites, such parameters influence the selection of a supramolecular template. For instance, in embodiments herein an effective supramolecular template comprises an organosilane having one or more dimensions of about 0.7 nm to realize hierarchically ordered lamellar mesoporous FAU zeolite, using FAU zeolite as a parent CMM, wherein the selected supramolecular template is generally constrained from entering pores of the FAU zeolite.

In certain embodiments parent CMM used in the methods include a zeolite having a SAR suitable for the particular type of zeolite. In general, the SAR of parent zeolites can be in the range of about 2-10000, 2-5000, 2-500, 2-100, 2-80, 5-10000, 5-5000, 5-500, 5-100, 5-80, 10-10000, 10-5000, 10-500, 10-100, 10-80, 50-10000, 50-5000, 50-1000, 50-500 or 50-100. In certain embodiments the SAR of the parent zeolite is greater than or equal to 5 or 10 to achieve long-range ordering. In embodiments with a SAR of less than 10, uniform mesoporosity and certain degree of ordering is attainable, and amorphous framework material remains in the product.

In certain embodiments the LMCMM 102 comprises hierarchically ordered CMM (such as zeolites) having well-defined long-range mesoporous ordering of two dimensional lamellar symmetry. These are characterized by defined mesoporous channel directions with CMM micropore channels in the walls of the mesostructure. The LMCMM having well-defined long-range mesoporous ordering of two dimensional lamellar symmetry recovered from synthesis possesses supramolecular template as described herein in the mesopores (that is, prior to calcination or extraction of the supramolecular template). In certain embodiments the hierarchically ordered LMCMM having well-defined long-range mesoporous ordering recovered from synthesis possesses micelles of supramolecular template as described herein in the mesopores (that is, prior to calcination or extraction of the supramolecular template). In certain embodiments the LMCMM 102 retains the structural integrity of the microporous zeolite structure by controlled incision of the parent zeolite followed by controlled reassembly of the zeolite oligomers under a controlled micellar curvature to yield the hierarchically ordered CMM with defined mesoporous two dimensional lamellar symmetry.

In certain embodiments, the LMCMM 102 is provided in the form of a composition of hierarchical lamellar material and supramolecular template material within mesopores thereof. In certain embodiments, LMCMM 102 is provided in the form of a composition of LMCMM and supramolecular template material comprising micelles of the supramolecular template material within mesopores thereof. The micelles are shaped to induce mesoporous ordering of lamellar symmetry. The supramolecular templates possess one or more dimensions larger than dimensions of micropores of the crystalline microporous material to constrain diffusion into micropores of the crystalline microporous material. The dimensions relate to a head group of a supramolecular template, a tail group of a supramolecular template, or a co-template arrangement that constrain diffusion into micropores of the CMM. In certain embodiments, a composition of matter herein is LMCMM 102 that contains supramolecular template material as shaped micelles 226.

In certain embodiments LMCMM 102 is synthesized using by base-mediated reassembly, by dissolution of the parent CMM to a level of structural building units that are oligomers of the parent CMM, and minimizing or avoiding amorphization/structural collapse. In certain embodiments the CMM dissolution and self-assembly is comprehensively controlled to produce LMCMM having mesoporous ordering of lamellar symmetry with the use of supramolecular templates. In certain embodiments the CMM dissolution and self-assembly is comprehensively controlled to produce LMCMM having mesoporous ordering of lamellar symmetry with the use of supramolecular templates and an ionic co-solute.

A method to make LMCMM 102 and examples thereof including CMM dissolution and self-assembly are disclosed in co-pending and commonly owned United Stated patent application Ser. No. 17/857,671 filed on Jul. 5, 2022 entitled “Methods for Synthesis of Hierarchically Ordered Crystalline Microporous Materials with Long-Range Mesoporous Order”, United Stated patent application Ser. No. 17/857,572 filed on Jul. 5, 2022 entitled “Hierarchically Ordered Crystalline Microporous Materials with Long-Range Mesoporous Order Having Lamellar Symmetry,” and United Stated patent application Ser. No. 18/151,782 filed Jan. 9, 2023 entitled “Methods For Synthesis Of Hierarchically Ordered Crystalline Microporous Materials With Long-Range Mesoporous Order” all of which are incorporated by reference herein.

With continued reference to FIG. 2, LMCMM 102 is subjected to steps for exfoliation/delamination, e.g., step 106 and step 110, as described with respect to FIG. 1, to obtain exfoliated LMCMM 114, that is, layers of crystalline microporous material with mesoporous order having lamellar symmetry.

In certain embodiments the LMCMM 102 comprises lamellar FAU zeolite. In certain embodiments herein, the lamellar FAU zeolite as the LMCMM 102 is obtained by bottom-up strategies. In certain embodiments herein, the lamellar FAU zeolite as the LMCMM 102 is obtained by top-down strategies.

In certain embodiments, the LMCMM 102 comprises lamellar FAU zeolite, and the exfoliating agent 104 comprises polystyrene, polybutadiene, polylactic acid, polyvinylpyrrolidone, polyethyleneimine or combinations comprising one of the foregoing polymers. In certain embodiments, the LMCMM 102 comprises lamellar FAU zeolite, and the exfoliating agent 104 comprises a polybutadiene source. In certain embodiments, the LMCMM 102 comprises lamellar FAU zeolite, and the exfoliating agent 104 in the form of a polybutadiene source comprises hydroxyl-terminated polybutadiene (HTPB), carboxyl-terminated polybutadiene (CTPB), polybutadiene, or combinations comprising one of the foregoing polybutadiene sources.

In certain embodiments the lamellar FAU zeolite as the lamellar crystalline microporous material 102 comprises lamellar FAU zeolite synthesized using a supramolecular template; wherein the material 102 also contains said supramolecular template to retain the lamellar structure prior to exfoliating; and wherein the exfoliating agent 104 is in the form of a polybutadiene source and comprises hydroxyl-terminated polybutadiene (HTPB), carboxyl-terminated polybutadiene (CTPB), polybutadiene, or combinations comprising one of the foregoing polybutadiene sources.

In certain embodiments the lamellar FAU zeolite as the lamellar crystalline microporous material 102 comprises lamellar FAU zeolite synthesized using a supramolecular template, wherein the supramolecular template contains at least one quaternary ammonium group, and at least one head group moiety selected from the group consisting of organosilanes, hydroxysilyls, alkoxysilyls, aromatics, branched alkyls, sulfonates, carboxylates, phosphates and combinations comprising one of the foregoing moieties, wherein an alkyl group bridging at least one of the quaternary ammonium groups and at least one of the head groups contains 1-10 carbon atoms; wherein the material 102 also contains said supramolecular template to retain the lamellar structure prior to exfoliating; and wherein the exfoliating agent 104 is in the form of a polybutadiene source and comprises hydroxyl-terminated polybutadiene (HTPB), carboxyl-terminated polybutadiene (CTPB), polybutadiene, or combinations comprising one of the foregoing polybutadiene sources.

In certain embodiments the lamellar FAU zeolite as the lamellar crystalline microporous material 102 comprises lamellar FAU zeolite synthesized using a supramolecular template, wherein the supramolecular template comprises dimethyloctadecyl(3-trimethoxysilyl-propyl)-ammonium or a derivative of dimethyloctadecyl(3-trimethoxysilyl-propyl)-ammonium; wherein the material 102 also contains said supramolecular template to retain the lamellar structure prior to exfoliating; and wherein the exfoliating agent 104 is in the form of a polybutadiene source and comprises hydroxyl-terminated polybutadiene (HTPB), carboxyl-terminated polybutadiene (CTPB), polybutadiene, or combinations comprising one of the foregoing polybutadiene sources.

In some embodiments, the exfoliated lamellar crystalline microporous material synthesized herein can be advantageously used over traditional zeolites. In some embodiments, the synthesized materials are hierarchical zeolites including hierarchically ordered zeolites (HOZs) possessing a mesoporous structure and FAU zeolitize mesopore walls that have exceptional properties. HOZs contain different layers of porosity, that is, mesopores and micropores. The synthesized exfoliated lamellar crystalline microporous materials offer advantages over traditional microporous zeolites by, for example, improving diffusion of guest species to the active sites, overcoming steric limitations, improving product selectivity, decreasing coke formation, improving hydrothermal stability, and improving accessibility of Brønsted acid sites and Lewis acid sites; and concomitantly, improved catalytic performance.

In certain embodiments, discrete layers of zeolites as provided herein, offer synthetic openings as homogeneous liquid phase reagents or as nano-sized units in themselves. In certain embodiments, discrete layers of zeolites as provided herein may be used in combination with other functional groups or zeolites, to allow for a diverse range of composite material generation.

Exfoliated layers of lamellar CMM, such as discrete layers of lamellar FAU zeolite, are effective as catalysts, or components of catalysts, in hydrocracking or fluid catalytic cracking of hydrocarbon oil. In certain embodiment, a hydrocracking method comprises contacting a hydrocarbon oil with the hydrocracking catalysts formed using exfoliated layers of lamellar CMM as described herein.

In certain embodiment, a fluid catalytic cracking method comprises contacting a hydrocarbon oil with exfoliated layers of lamellar CMM as described herein. In certain embodiments, CMM in the exfoliated layers of lamellar CMM as a catalyst for fluid catalytic cracking comprises one or more zeolite types AEI, *BEA, CHA, FAU, MFI, MOR, LTL, LTA or MWW. In certain embodiments the CMM in the exfoliated layers of lamellar CMM as a catalyst for fluid catalytic cracking comprises FAU zeolite.

The exfoliated layers of lamellar CMM can be used as a support having loaded thereon one or more active metal components as a hydrocracking catalyst. The active metal components are loaded, for example, carried on surfaces including the mesopore wall surfaces, micropore wall surfaces or mesopore and micropore wall surfaces; the active metal components are loaded according to known methods, such as providing an aqueous solution of the active metal components and subjecting exfoliated layers of lamellar CMM as catalyst support material to immersion, incipient wetness, and evaporative, or any other suitable method. In certain embodiments, the CMM comprises zeolite. In certain embodiments the CMM in the exfoliated layers of lamellar CMM as a hydrocracking catalyst comprises one or more zeolite types AEI, *BEA, CHA, FAU, MFI, MOR, LTL, LTA or MWW. In certain embodiments the CMM in the exfoliated layers of lamellar CMM as a hydrocracking catalyst comprises FAU zeolite.

The content of the exfoliated layers of lamellar CMM, and the active metal component, are appropriately determined according to the object. In certain embodiments, a hydrocracking catalyst comprises as a support the exfoliated layers of lamellar CMM, and an inorganic oxide component, typically as a binder and/or granulating agent. For example, support particles (prior to loading of one or more hydrocracking active metal components) can contain exfoliated layers of lamellar CMM in the range of about 0.1-90, 0.1-80, 0.1-70, 0.1-50, 0.1-40, 2-90, 2-80, 2-70, 2-50, 2-40, 20-80, 20-70, 20-50, or 20-40 mass %, with the remaining content being the inorganic oxide. In certain embodiments, support particles (prior to loading of one or more hydrocracking active metal components) can contain exfoliated layers of lamellar CMM in the range of about 0.1-80, 0.1-70, 0.1-50, 0.1-40, 2-80, 2-70, 2-50, 2-40, 20-80, 20-70, 20-50, or 20-40 mass %, with the remaining content being the inorganic oxide and one or more other zeolitic materials.

As the inorganic oxide component, any material used in hydrocracking or other catalyst compositions in the related art can be used. Examples thereof include alumina, silica, titania, silica-alumina, alumina-titania, alumina-zirconia, alumina-boria, phosphorus-alumina, silica-alumina-boria, phosphorus-alumina-boria, phosphorus-alumina-silica, silica-alumina-titania, silica-alumina-zirconia, alumina-zirconia-titania, phosphorous-alumina-zirconia, alumina-zirconia-titania and phosphorus-alumina-titania.

The active metal component can include one or more metals or metal compounds (oxides or sulfides) known in the art of hydrocracking, including those selected from the Periodic Table of the Elements IUPAC Groups 6, 7, 8, 9 and 10. In certain embodiments the active metal component(s) comprises one or more metal form, oxides or sulfides of Mo, W, Co, Ni, or a combination thereof. In certain embodiments the active metal component(s) comprises one or more noble metals, for example one or more of Pt, Pd, Rh, Re, Ir, Ru, or a combination thereof. The additional active metal component may be contained in catalyst in effective concentrations. For example, total active component content in hydrocracking catalysts can be present in an amount as is known in the related art, for example about 0.01-40, 0.1-40, 1-40, 2-40, 5-40, 0.01-30, 0.1-30, 1-30, 2-30, 5-30, 0.01-20, 0.1-20, 1-20, 2-20 or 5-20 W % in terms of metal, oxide or sulfide. In certain embodiments, active metal components are loaded using a solution of oxides, and prior to use, the hydrocracking catalysts are sulfided.

### EXAMPLES

Characterizations herein were carried out as follows. Powder XRD patterns were obtained using a Bruker D8 twin diffractometer, operating at 40 kV and 40 mA having Cu Kα radiation (2 =0.154 nm) and a step-size of 0.02°. N2 physisorption measurements were conducted at 77 K using a Micromeritics ASAP 2420 instrument. All samples were degassed at 350° C. for 12 h before the analysis. The specific surface areas and pore size distributions were calculated using the Brunauer-Emmett-Teller (BET) and non-local density functional theory (NLDFT) models. A t-plot method was used to calculate the micropore volume. High-resolution transmission electron microscopy (TEM) studies were undertaken using a FEI-Titan ST electron microscope operated at 300 kV.

Example 1: A procedure for synthesis of two dimensional lamellar ordered mesoporous FAU zeolite is provided. A parent zeolite is provided possessing the FAU framework, zeolite Y (obtained from Zeolyst International, product name CBV 720, also referred to as zeolite H-Y, having a SAR of about 30). A quantity of 1.2 grams of urea was dissolved in 60.0 grams of water to form a homogeneous solution. To this mixture, 2.0 grams of the parent zeolite was added and stirred. 0.92 grams of sodium perchlorate (NaCl04) was added and stirred for 10 minutes. Subsequently, 3.0 milliliters of an organosilane, dimethyloctadecyl(3-trimethoxysilyl-propyl)-ammonium chloride DOAC (42.0 mass % in methanol) was added. The resulting solution was stirred for 0.5 hours, followed by hydrothermal treatment at 130° C. for 72 hours. The resulting solids were filtered, washed with water and dried at 120° C. for 24 hours.

The parent zeolite and as-made zeolite formed in accordance this procedure were characterized. The parent zeolite was characterized by: a micropore BET surface area of 640 m²/g; a total BET surface area of 811 m²/g; a micropore pore volume of 0.25 cm³/g; and a total pore volume of 0.44 cm³/g. The two dimensional lamellar ordered mesoporous symmetry FAU zeolite of Example 1 was characterized by: a micropore unit cell parameter value calculated from calcined high-angle XRD patterns of 24.22 Å; a mesopore unit cell parameter value calculated from as-synthesized low-angle XRD pattern of 4.1 nm; Si/Al value determined from 29Si magic angle spinning-NMR of 14.6; a micropore BET surface area of 533 m²/g; a total BET surface area of 765 m²/g; a micropore pore volume of 0.21 cm³/g; and a total pore volume of 0.48 cm³/g.

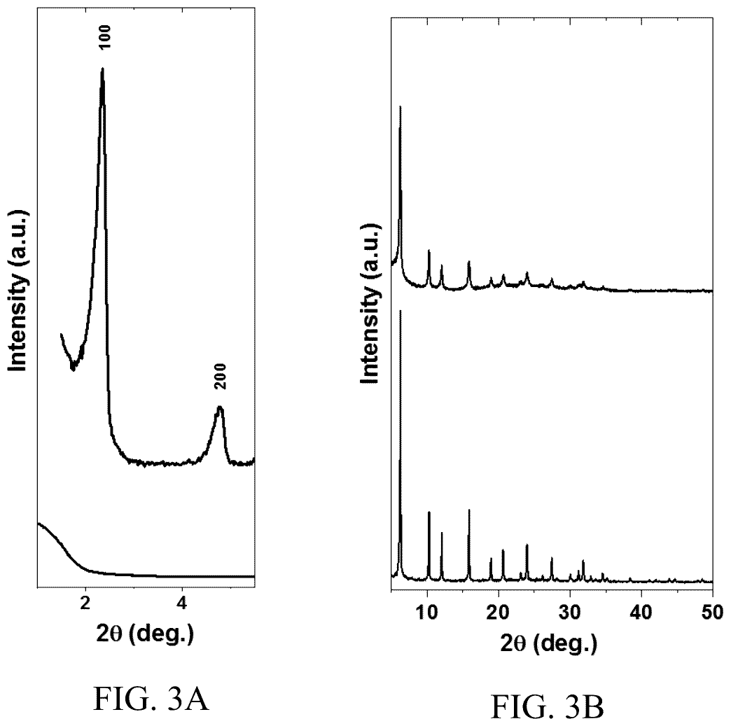

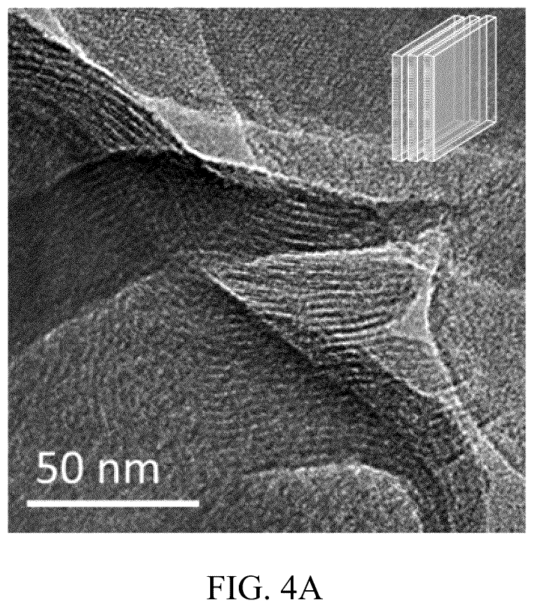

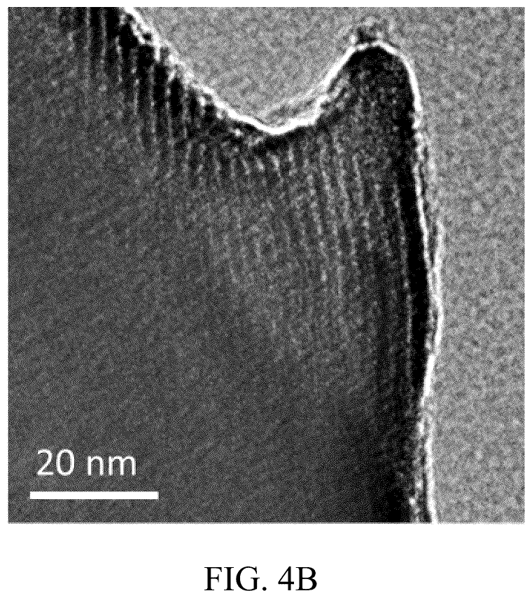

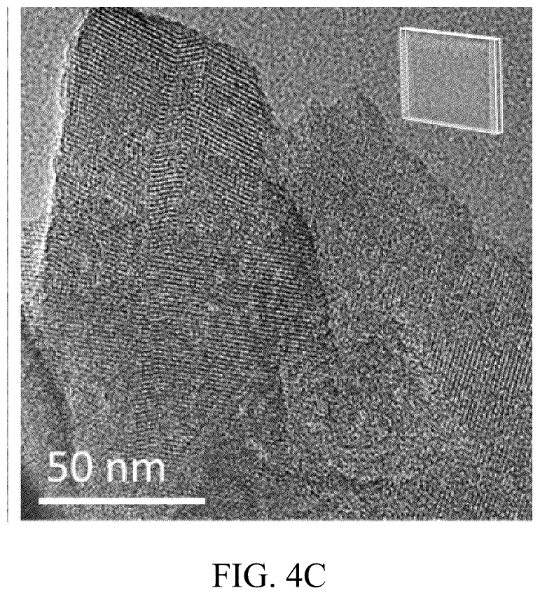

According to Example 1, a hierarchically ordered FAU-type framework exhibiting two dimensional lamellar (p2) mesopore symmetry is prepared by a methodical post-synthetic reassembly. The hierarchically ordered zeolite is a two dimensional lamellar ordered mesoporous FAU-type zeolite possesses lamellar mesoporous channels present in the direction with FAU micropore channels in the walls and mass of the mesostructure between mesopores. FIG. 3A depicts low-angle XRD patterns and FIG. 3B depicts high-angle XRD patterns, wherein the lower diffractogram in each corresponds to commercial-USY and the upper diffractogram in each corresponds to the two dimensional lamellar ordered mesoporous symmetry zeolite Y synthesized in Example 1. The high-degree of long-range ordering is apparent from FIG. 3A, where low-angle XRD patterns exhibit Bragg's reflection peaks 100 and 200 indicative of two dimensional lamellar (p2) mesopore symmetry. The retention of the underlying zeolite structure is apparent from FIG. 3B, where high-angle XRD patterns are consistent with those for the parent zeolite, FAU zeolite. FIG. 4A shows a TEM micrograph at a scale of 50 nanometers in a planar direction [100]. FIG. 4B shows a TEM micrograph at a scale of 20 nanometers. FIG. 4C shows a TEM micrograph at a scale of 50 nanometers in a planar direction [110].

Example 2: Exfoliated two dimensional lamellar ordered mesoporous symmetry FAU zeolite layers were isolated and analyzed. A quantity of dried two dimensional lamellar ordered mesoporous symmetry zeolite Y from Example 1 was dispersed in hydroxyl-terminated polybutadiene by ultrasonication for 1 hour at 21° C. to produce a 9.0 mass % two dimensional lamellar ordered mesoporous symmetry zeolite Y mixture. The resulting mixture was dispersed in toluene by ultrasonication for 20 minutes resulting in a 1 mass % two dimensional lamellar ordered mesoporous symmetry zeolite Y suspension. The resulting suspension was centrifuged at 30000 RPM for 2 hours. The obtained sediment was redispersed in 120 mL (4×30 mL) of toluene followed by centrifugation at 30000 RPM for 1 hour. This process was repeated twice. The final sediment was dispersed in 120 mL (4×30 mL) of toluene by ultrasonication and allowed to settle for 30 minutes. After this, the top 25% of the suspension was collected from the centrifuge tube and was re-dispersed in 20 mL of n-octanol. This produced a suspension containing exfoliated two dimensional lamellar ordered mesoporous symmetry zeolite Y, which was used for TEM analysis.

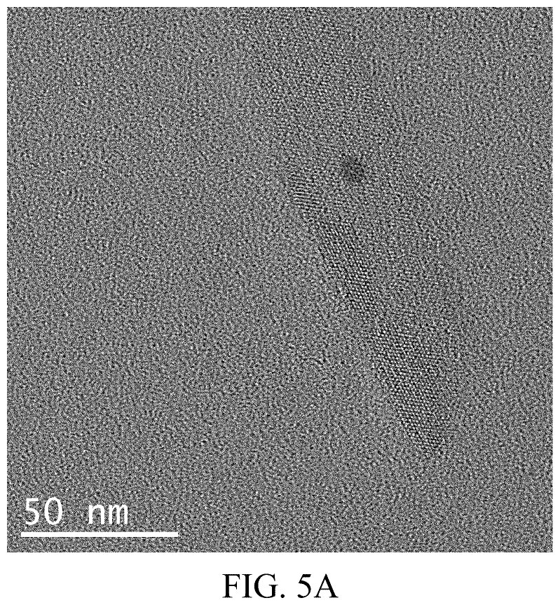

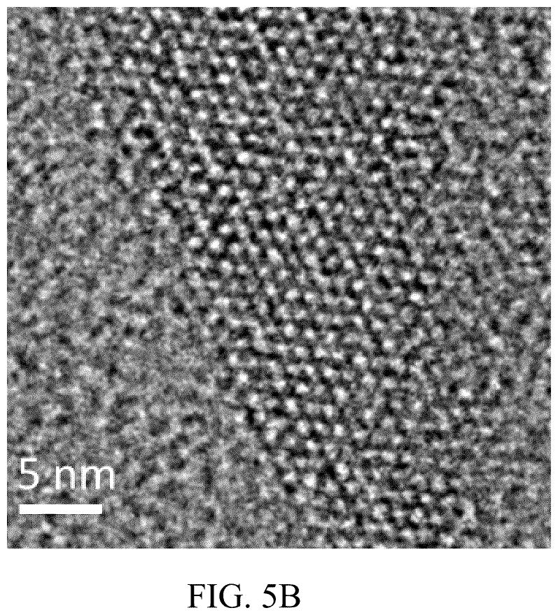

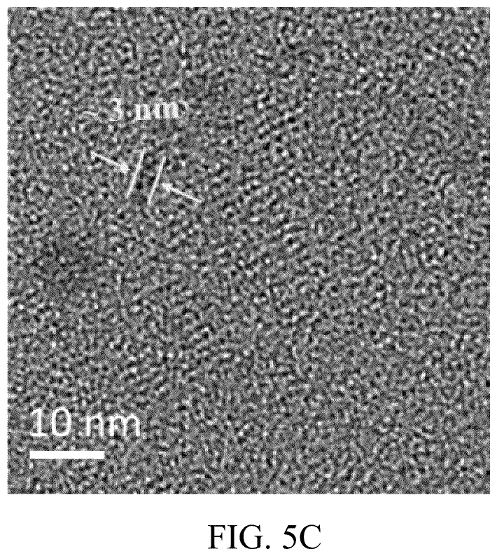

FIGS. 5A-5C are the TEM images of the exfoliated FAU-type zeolite nanosheets at scales of 50, 5 and 10 nanometers, respectively, formed in Example 3. The thickness of the nanosheets range from 3.0-9.0 nm comprising monolayers and multilayers. The monolayers are formed by exfoliation of the nanosheets; multilayers are formed due to intrinsic intercalation occurring during the synthesis and exfoliation treatments.

It is to be understood that like numerals in the drawings represent like elements through the several figures, and that not all components and/or steps described and illustrated with reference to the figures are required for all embodiments or arrangements. Further, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “including,” “comprising,” or “having,” “containing,” “involving,” and variations thereof herein, when used in this specification, specify the presence of stated features, integers, steps, operations, elements, and/or components, but do not preclude the presence or addition of one or more other features, integers, steps, operations, elements, components, and/or groups thereof.

Notably, the figures and examples above are not meant to limit the scope of the present disclosure to a single implementation, as other implementations are possible by way of interchange of some or all the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific implementations will so fully reveal the general nature of the disclosure that others can, by applying knowledge within the skill of the relevant art(s), readily modify and/or adapt for various applications such specific implementations, without undue experimentation, without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown are drawings accordingly to one example and other dimensions can be used without departing from the disclosure.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. A composition comprising lamellar FAU zeolite in sheets of thicknesses of about 3-2000 nanometers.

2. (canceled)

3. The composition of claim 1, wherein the thickness of the sheets is about 3-500 nanometers.

4. (canceled)

5. The composition of claim 1, wherein the thickness of the sheets is about 3-50 nanometers.

6. The composition of claim 1, wherein the sheets are derived from exfoliation or delamination of lamellar FAU zeolite including a supramolecular template material between layers of the lamellar FAU zeolite.

7. A method to obtain sheets of lamellar crystalline microporous material comprising:
dispersing lamellar mesoporous crystalline microporous material (LMCMM) and exfoliating agent, wherein LMCMM includes a supramolecular template material between layers of lamellae, to yield a suspension of LMCMM and exfoliating agent;
dispersing separating agent in the suspension of LMCMM and exfoliating agent to produce a suspension of separating agent, LMCMM and exfoliating agent; and
recovering separated sheets of crystalline microporous material from the suspension of separating agent, LMCMM and exfoliating agent.

8. The method of claim 7, wherein recovering sheets of crystalline microporous material from the suspension of separating agent, LMCMM and exfoliating agent is by separating the sheets of crystalline microporous material from a supernatant, and wherein all or a portion of the supernatant is redispersed into the suspension of separating agent, LMCMM and exfoliating agent, further comprising dispersing additional separating agent in the recovered sheets of crystalline microporous material to form an additional suspension, and recovering further separated sheets of crystalline microporous material from the additional suspension, and wherein recovering separated sheets of crystalline microporous material from the suspension of separating agent, LMCMM and exfoliating agent comprises centrifuging and recovering solids from the top 10-50% after centrifuging.

9. (canceled)

10. (canceled)

11. (canceled)

12. The method of claim 7, wherein the exfoliating agent comprises a polymer selected from the group consisting of polystyrenes, polybutadienes, polylactic acids, polyvinylpyrrolidones, polyethyleneimines and combinations of one or more of the foregoing polymers, and wherein the separation agent is a solvent selected from the group consisting of toluene, dichloromethane (DCM), chloroform, n-octanol, chlorobenzene, chloromethane, and combinations of one or more of the foregoing solvents.

13. The method of claim 7, wherein the exfoliating agent comprises a polybutadiene.

14. The method of claim 13, wherein the polybutadiene is selected from the group consisting of hydroxyl-terminated polybutadiene (HTPB), carboxyl-terminated polybutadiene (CTPB), polybutadiene, and combinations of one or more of the foregoing polybutadienes.

15. (canceled)

16. The method of claim 13, wherein the separation agent comprises toluene.

17. The method of claim 16, wherein
dispersing the LMCMM and exfoliating agent is by sonication or ultrasonication and occurs for a time period of about 0.2-5 hours, at a temperature of about 20-60° C., and at a mass ratio of LMCMM to exfoliating agent of about 1:4-1:20,
dispersing separating agent in the suspension of LMCMM and exfoliating agent is by sonication or ultrasonication and occurs for a time period of about 0.2-5 hours, at a temperature of about 20-60° C., and at a mass ratio of LMCMM to separating agent of about 1:25-1:1000, and
recovering separated sheets of crystalline microporous material from the suspension of separating agent, LMCMM and exfoliating agent is by centrifugation and decanting.

18. The method of claim 7, wherein the crystalline microporous material is a zeolite having a framework selected from the group consisting of ABW, ACO, AEI, AEL, AEN, AET, AFG, AFI, AFN, AFO, AFR, AFS, AFT, AFV, AFX, AFY, AHT, ANA, ANO, APC, APD, AST, ASV, ATN, ATO, ATS, ATT, ATV, AVE, AVL, AWO, AWW, BCT, BEC, BIK, BOF, BOG, BOZ, BPH, BRE, BSV, CAN, CAS, CDO, CFI, CGF, CGS, CHA, -CHI, -CLO, CON, CSV, CZP, DAC, DDR, DFO, DFT, DOH, DON, EAB, EDI, EEI, EMT, EON, EPI, ERI, ESV, ETL, ETR, ETV, EUO, EWO, EWS, EZT, FAR, FAU, FER, FRA, GIS, GIU, GME, GON, GOO, HEU, IFO, IFR, -IFT, -IFU, IFW, IFY, IHW, IMF, IRN, IRR, -IRY, ISV, ITE, ITG, ITH, ITR, ITT, -ITV, ITW, IWR, IWS, IWV, IWW, JBW, JNT, JOZ, JRY, JSN, JSR, JST, JSW, KFI, LAU, LEV, LIO, -LIT, LOS, LOV, LTA, LTF, LTJ, LTL, LTN, MAR, MAZ, MEI, MEL, MEP, MER, MFI, MFS, MON, MOR, MOZ, MRT, MSE, MSO, MTF, MTN, MTT, MTW, MVY, MWF, MWW, NAB, NAT, NES, NON, NPO, NPT, NSI, OBW, OFF, OKO, OSI, OSO, OWE, -PAR, PAU, PCR, PHI, PON, POR, POS, PSI, PTO, PTT, PTY, PUN, PWN, PWO, PWW, RHO, -RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, SFW, SGT, SIV, SOD, SOF, SOR, SOS, SOV, SSF, SSY, STF, STI, STT, STW, -SVR, SVV, SWY, -SYT, SZR, TER, THO, TOL, TON, TSC, TUN, UEI, UFI, UOS, UOV, UOZ, USI, UTL, UWY, VET, VFI, VNI, VSV, WEI, -WEN, YFI, YUG, ZON, *BEA, *CTH, *-EWT, *-ITN, *MRE, *PCS, *SFV, *-SSO, *STO, *-SVY and *UOE.

19. The method of claim 18, wherein the crystalline microporous material is a zeolite having a framework selected from the group consisting of AEI, *BEA, CHA, FAU, MFI, MOR, LTL, LTA and MWW.

20. The method of claim 19, wherein the crystalline microporous material is a zeolite having FAU framework.

21. The method of claim 7, wherein the LMCMM comprises hierarchically ordered crystalline microporous material having well-defined long-range mesoporous ordering of lamellar symmetry comprising mesopores having walls of crystalline microporous material and a mass of mesostructure between mesopores of crystalline microporous material, wherein at least a portion of the mesopores contain micelles of supramolecular templates shaped to induce mesoporous ordering of lamellar symmetry, and wherein the supramolecular templates possess one or more dimensions larger than dimensions of micropores of the crystalline microporous material to constrain diffusion into micropores of the crystalline microporous material, wherein the dimensions relate to a head group of a supramolecular template, a tail group of a supramolecular template, or a co-template arrangement that constrain diffusion into micropores of the crystalline microporous material.

22. The method of claim 21, wherein the LMCMM comprises hierarchically ordered crystalline microporous material having a high-degree of long-range mesoporous ordering, and wherein the LMCMM is synthesized by:
forming an aqueous suspension of a parent crystalline microporous material having an underlying microporous structure, an alkaline reagent and a supramolecular template; and
hydrothermally treating the aqueous suspension under conditions effective for mesophase transition to dissolve/incise parent crystalline microporous material into oligomeric units of the parent crystalline microporous material, form shaped micelles of the supramolecular template, and reorganize the oligomeric units around the shaped micelles into hierarchically ordered mesostructures.

23. The method of claim 22, wherein the aqueous suspension further comprises an ionic co-solute, wherein the parent crystalline microporous material comprises FAU zeolite, the alkaline agent comprises urea, and the ionic co-solute comprises perchlorate.

24. (canceled)

25. The method of claim 7, wherein a lamellar mesophase of the LMCMM possesses p2 or p1 or pm symmetry and wherein long-range ordering of the LMCMM is observable by microscopy viewing an electron beam parallel or perpendicular to a zone axis.

26. The method of claim 25, wherein a lamellar mesophase of the LMCMM possesses p2 symmetry and secondary peaks in XRD are present at a (200) reflection.

27. (canceled)

28. (canceled)

29. (canceled)

30. A method to obtain sheets of lamellar FAU zeolite comprising:
dispersing lamellar FAU zeolite and exfoliating agent, wherein lamellar FAU zeolite includes a supramolecular template material between layers of lamellae, to yield a suspension of lamellar FAU zeolite and exfoliating agent;
dispersing separating agent in the suspension of lamellar FAU zeolite and exfoliating agent to produce a suspension of separating agent, lamellar FAU zeolite and exfoliating agent; and
recovering separated sheets of crystalline microporous material from the suspension of separating agent, lamellar FAU zeolite and exfoliating agent.
